(19) United States
(12) Patent Application Publication
(10) Pub. No.: US 2008/0310042 A1
(43) Pub. Date: Dec. 18, 2008

(54) REFLECTOR FILM AND PRODUCTION METHOD THEREOF, AND LIGHTING APPARATUS USING THE SAME

(76) Inventors: Yoshio Suzuki, Tokyo (JP); Shuichi Taya, Tokyo (JP)

Correspondence Address: CERMAK KENEALY & VAIDYA, LLP, 515 EAST BRADDOCK RD SUITE B, Alexandria, VA, 22314, US

(21) Appl. No.: 12/027,309

(22) Filed: Feb. 7, 2008

(30) Foreign Application Priority Data
Feb. 7, 2007 (JP) 2007-027604

(51) Int. Cl. G02B 5/10; G02B 5/08; G02B 1/10; F21V 7/22

(52) U.S. Cl. 359/883; 427/162; 362/516

(57) ABSTRACT

A reflector film can have a high heat resistance and can maintain a high reflectance (or effectively prevent the decrease in the reflectance) when overlaid with a particular protective film. A lighting apparatus can also be configured for use with such a reflector film. The reflector film can include a silver or silver alloy film deposited on a substrate, and a titanium or titanium alloy film deposited on the silver or silver alloy film to serve as a protective film.

This application claims the priority benefit under 35 U.S.C. § 119 of Japanese Patent Application No. 2007-027604 filed on Feb. 7, 2007, which is hereby incorporated in its entirety by reference.

### BACKGROUND

1. Technical Field

The presently disclosed subject matter relates to a reflector film and a production method thereof, as well as to a lighting apparatus using the reflector film.

2. Description of the Related Art

FIG. 1 shows a lighting apparatus. Specifically, the figure shows an exemplary construction of a headlamp lighting device used in vehicles. With reference to FIG. 1, the lighting apparatus includes a lens cover 40, a lamp body 50 that forms a lamp chamber 60 together with the lens cover 40, a light source bulb 30 arranged within the lamp chamber 60, and a reflector 20 arranged about the light source bulb 30. This lighting apparatus is configured such that a light beam L emitted from the light source bulb 30 toward the reflector 20 is reflected by the reflector 20 and exits through the lens cover 40 to illuminate the front of the lighting device. The reference numeral 10 denotes an extension reflector arranged between the reflector 20 and the lamp body 50. The extension reflector 10 is provided for decorative purpose.

The reflector 20 has a reflector film as one of its components. As an example, a conventional reflector is shown in FIG. 2. This reflector includes a synthetic resin substrate 101, an undercoat 102 made of an acrylic resin deposited on the surface of the synthetic resin substrate 101, an aluminum film 103 deposited by vapor deposition or sputtering to serve as a reflective surface, and a protective film 104 deposited on the surface of the aluminum film 103. The protective film 104 is deposited after deposition of the aluminum film 103 and is formed either as an oxidized silicon protective film by a plasma CVD technique or as an acrylic protective film by a coating technique. The aluminum reflective surface formed by vapor deposition can achieve a reflectance of approximately 85 to 90% in the entire visible spectrum and is thus widely used in lighting devices of automobiles, motorcycles and other vehicles. However, the 10 to 15% loss of the emitted light caused by the aluminum film may create a need for more effective reflective materials.

On the other hand, deposited silver films that have a reflectance of approximately 95% have been developed and used as reflectors in indoor lights and LCD backlights. While application of this reflective material in vehicular lighting device has been considered, the silver film has a drawback in that it is susceptible to color change because the silver used in the film is chemically unstable and readily reacts with sulfur dioxide, moisture, oxygen or hydrogen sulfide in the atmosphere, forming brown or black silver sulfide or silver oxide.

Thus, protective films have been developed to protect the surface of a silver film. For example, topcoats of acrylic resins or silicone resins are disclosed in Japanese Patent Application Laid-Open No. 2006-86095 (corresponding to U.S. Patent Publication No. 2006/0062009A1) and Japanese Patent Application Laid-Open No. 2000-106018. However, these materials tend to decrease the reflectance of the reflective surface. In addition to this, they are less durable. For these and other reasons, these protective films are not used in automobiles or vehicles at present.

As described above, when highly reflective silver films or silver alloy films are used, particular types of resin materials should be used in the conventional protective films (topcoats) for reflective surfaces. Accordingly, the light is absorbed or scattered by these resin materials, resulting in a decreased reflectance.

In addition, when a certain type of resin is used to form the protective film for a reflector, the heat resistance of the reflector is regulated by the heat resistance of the resin that is used. Specifically, the reflective surface becomes extremely hot (for example, 200° C. or above) in projector-type reflectors, in reflectors that use a high-intensity light source, or in reflectors in which the light source is arranged close to the reflective surface. The resin materials used in the protective film tend to deteriorate in these reflectors. Also, the types of materials that can be used in the protective film are limited.

Furthermore, because these resin materials are applied by coating, dust particles tend to stick to the coated surfaces. As a result, it is difficult to achieve high production yields.

The use of resin materials in the protective film also requires the use of organic solvents in the coating process. Some of these organic solvents may be harmful to the environment and to the health of the workers.

Accordingly, there remains a need for a reflector film that has a high heat resistance and maintains a high reflectance (or effectively prevents the decrease in the reflectance) even when overlaid with a protective film, as well as a lighting apparatus that uses the reflector film.

There is also a need for a method for producing a reflector film that can keep dust particles from sticking to the reflector film during production, thus, achieving high production yields, and eliminating or reducing the use of organic solvents.

In accordance with one aspect of the presently disclosed subject matter, a reflector film can include: a silver film or a silver alloy film deposited on a substrate; and a film selected from the group consisting of a titanium film, a titanium alloy film, and a SiAlON (general formula Si_{(6-Z)}Al_{Z}O_{Z}N_{(8-Z)} (0<Z≦4.2)) film serving as a protective film deposited on the silver film or the silver alloy film.

In the above-described reflector film, the silver film or the silver alloy film may have a thickness of 50 nm to 500 nm and a titanium film or titanium alloy film having a thickness of 0.1 nm to 2 nm may be deposited on the silver film or the silver alloy film.

Alternatively, in the above-described reflector film, the silver film or the silver alloy film may have a thickness of 50 nm to 500 nm and a SiAlON (general formula Si_{(6-Z)}Al_{Z}O_{Z}N_{(8-Z)} (0<Z≦4.2)) film having a thickness of 0.5 nm to 10 nm may be deposited on the silver film or the silver alloy film.

In accordance with another aspect of the presently disclosed subject matter, a reflector can include: a substrate having a predetermined shape; a silver film or a silver alloy film deposited on the substrate; and a film selected from the group consisting of a titanium film, a titanium alloy film, and a SiAlON (general formula Si_{(6-Z)}Al_{Z}O_{Z}N_{(8-Z)} (0<Z≦4.2)) film serving as a protective film deposited on the silver film or the silver alloy film.

In the above-described reflector, the silver film or the silver alloy film may have a thickness of 50 nm to 500 nm and a titanium film or titanium alloy film having a thickness of 0.1 nm to 2 nm may be deposited on the silver film or the silver alloy film.

Alternatively, in the above-described reflector, the silver film or the silver alloy film may have a thickness of 50 nm to 500 nm and a SiAlON (general formula Si_{(6-Z)}Al_{Z}O_{Z}N_{(8-Z)} (0<Z≦4.2)) film having a thickness of 0.5 nm to 10 nm may be deposited on the silver film or the silver alloy film.

The reflector as described above may be used in a vehicular lighting device, and in particular, a projector type headlight.

In the reflector, the predetermined shape of the substrate may be one selected from a revolved paraboloid, a spheroid, a free curved surface, etc.

In accordance with another aspect of the presently disclosed subject matter, a method for producing a reflector film can include: depositing a silver or silver alloy film on a substrate by sputtering; and subsequently depositing a film selected from the group consisting of a titanium film, a titanium alloy film, and a SiAlON (general formula Si_{(6-Z)}Al_{Z}O_{Z}N_{(8-Z)} (0<Z≦4.2)) film by sputtering.

In accordance with still another aspect of the presently disclosed subject matter, a lighting apparatus can include a light source and a reflector as defined above arranged about the light source.

The above defined lighting apparatus can be used in a vehicular lighting device, and in particular, a projector type headlight.

In the lighting apparatus as defined above, the reflector may have a configuration selected from a revolved paraboloid, a spheroid, a free curved surface, etc.

In accordance with some aspects of the presently disclosed subject matter, the reflector film can include a silver film or a silver alloy film deposited on a predetermined substrate, and any of a titanium film, a titanium alloy film and a SiAlON (general formula Si_{(6-Z)}Al_{Z}O_{Z}N_{(8-Z)} (0<Z≦4.2)) film deposited on the silver or silver alloy film to serve as a protective film. Accordingly, the reflector film having such a construction can have a high heat resistance and maintain a high reflectance (or effectively prevent the decrease in the reflectance) even when overlaid with a protective film.

In accordance with the other aspects of the presently disclosed subject matter, the production method can include depositing a silver film or a silver alloy film on a substrate by sputtering, and subsequently depositing any of a titanium film, a titanium alloy film and a SiAlON (general formula Si_{(6-Z)}Al_{Z}O_{Z}N_{(8-Z)} (0<Z≦4.2)) film by sputtering. In this manner, the method can keep dust particles from sticking to the reflector film during production (thus achieving high production yields) and can eliminate or reduce steps which use organic solvents.

In accordance with the other aspects of the presently disclosed subject matter, the lighting apparatus can include a light source and a reflector arranged about the light source, with the reflector including the above-described reflector film. The reflector having such a construction can maintain its high quality and also improves the quality of the lighting apparatus.

### BRIEF DESCRIPTION OF THE DRAWINGS

These and other characteristics, features, and advantages of the presently disclosed subject matter will become clear from the following description with reference to the accompanying drawings, wherein:

FIG. 1 is a diagram showing an exemplary construction of a lighting apparatus;

FIG. 2 is a diagram showing a construction of a conventional reflector film;

FIG. 3 is a diagram showing an exemplary construction of a reflector film made in accordance with principles of the presently disclosed subject matter;

FIG. 4 is a diagram showing a more specific construction of the reflector film of FIG. 3;

FIG. 5 is a diagram showing an exemplary construction of a sputtering apparatus for the production of the reflector film;

FIG. 6 is a diagram showing an other exemplary construction of a reflector film made in accordance with principles of the presently disclosed subject matter;

FIG. 7 is a diagram showing a more specific construction of the reflector film of FIG. 6; and

FIG. 8 is a graph showing the relationship between the thickness of SiAlON film and sulfuration of silver.

### DETAILED DESCRIPTION OF EXEMPLARY EMBODIMENTS

Exemplary embodiments in accordance with the presently disclosed subject matter will be described in detail hereinafter with reference to the accompanying drawings.

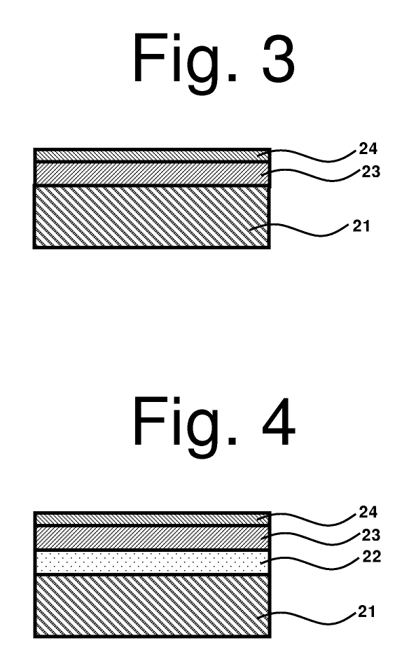

FIG. 3 is a diagram showing an exemplary construction of a reflector film according to a first exemplary embodiment of the presently disclosed subject matter. The reflector film shown in FIG. 3 can have a silver film or a silver alloy film 23 deposited on a substrate 21, and a titanium film or a titanium alloy film 24 deposited on the silver or silver alloy film 23 to serve as a protective film.

In this instance, the substrate 21 may be a resin substrate, a metal substrate or a glass substrate.

The silver or silver alloy film 23 can have a thickness of 50 nm to 500 nm, and the titanium or titanium alloy film can have a thickness of 0.1 nm to 2 nm.

While the silver or silver alloy film 23 may be directly deposited on the substrate 21, the film 23 may be deposited on an undercoat 22 (such as acrylic resin undercoat) or the like deposited on the substrate 21, as shown in FIG. 4.

In the reflector film having the above-described construction, the titanium or titanium alloy film serving as the protective film can help keep the reflectance of the reflector film high. While resin-based protective films absorb or scatter the reflected light, resulting in a decrease in the reflectance of the silver or silver alloy film by 5 to 10%, titanium or a titanium alloy can be deposited on the silver or silver alloy film to form an ultra-thin film. Such an ultra-thin film does not substantially affect the reflectance of the silver or silver alloy film, so that the reflectance of the reflector film remains substantially the same as that of the silver or silver alloy film.

The metal (titanium)-based protective film is highly resistant to heat. Specifically, the reflective surface becomes extremely hot (for example, 200° C. or above) in projector-type reflectors, in reflectors that use a high-intensity light source, or in reflectors in which the light source is arranged close to the reflective surface. Thus, the use of a resin material in the protective film of these reflectors not only leads to deterioration of the resin material, but also limits the types of materials that can be used in the protective film. According to the presently disclosed subject matter, however, the titanium or titanium alloy film used as the protective film is a metal film and is more suitable for use in reflectors that are exposed to high temperatures than the resin-based protective film.

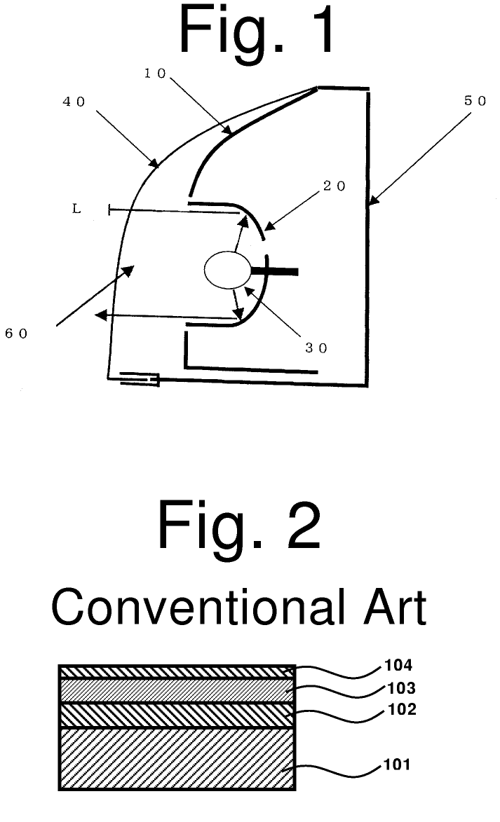

The above-described reflector film in accordance with the first exemplary embodiment of the presently disclosed subject matter can be used, for example, in the reflector 20 of the lighting apparatus (headlamp) shown in FIG. 1. In such a case, the reflector film of the first exemplary embodiment can ensure a high reflectance. This property, together with its high heat resistance, can help maintain high quality of the reflector for a longer period of time, thus improving the quality of the lighting apparatus.

When the reflector film is used in such a reflector for automobiles, the substrate of the reflector may have a predetermined shape having a revolved paraboloid, a spheroid, a free curved surface, and the like, which can be selected in accordance with its purpose and/or specification. Furthermore, the effects of the presently disclosed subject matter can be utilized for a reflector arranged near a light source which generates a significant amount of heat. Examples of such a lighting device include, but are not limited to, a projector type headlight with a reflector having a revolved paraboloid.

The reflector films made in accordance with the presently disclosed subject matter find applications in reflectors and extension reflectors for automobile lamps and motorcycles, reflectors for lighting apparatuses, decorative lights, automobile headlamps, lighting products in general, outdoor lighting fixtures and backlights, as well as in electrodes and reflection mirrors for LED lighting devices, displays, optical discs and other electronic equipment.

The process for forming the reflector film having a construction in accordance with the first exemplary embodiment of the presently disclosed subject matter (shown in FIG. 3 or 4) can be carried out by sputtering. Specifically, the silver or silver alloy film is first deposited on a predetermined substrate by sputtering, and the titanium or titanium alloy film is subsequently deposited thereon also by sputtering.

For example, an undercoat 22 is applied to the surface of a synthetic resin material 21. Silver 23 is then deposited on the surface of the undercoat 22 by sputtering. Subsequently, titanium 24 is deposited also by sputtering. Silver 23 is typically deposited to a thickness of 50 nm or more, and generally to a thickness in the range of 50 nm to 500 nm. This silver may be any silver-based material containing 95% or more pure silver. For example, a silver alloy material containing metals such as copper, palladium, neodymium, gold, bismuth, indium and magnesium may be used. Titanium 24 is typically deposited to a thickness of 0.1 nm or more, and generally to a thickness in the range of 0.1 nm to 2 nm. Titanium 24 may be any titanium alloy instead of pure titanium, the alloy containing 50% or more titanium.

The above-described production method in which the entire deposition process is carried out by sputtering can effectively keep dust particles from sticking to the reflector film during the deposition process. Thus, high production yields can be achieved. In contrast to conventional coating techniques, the deposition of the protective film by sputtering is effective in preventing sticking of dust particles to the film and can thus increase the production yield.

Since the deposition is a dry process, the method does not require the use of organic solvents. In contrast to coating techniques that require organic solvents, the deposition of the protective film by sputtering causes less environmental load and is advantageous in view of the health of the workers.

As a first example of the production of the reflector film, a sputtering apparatus as shown in FIG. 5 was used to deposit silver and titanium on a substrate. Specifically, the sputtering apparatus has a vacuum chamber 6 in which a silver target 1, a titanium target 2, a substrate holder 4 positioned above the targets, and a rotary shaft 5 for rotating the substrate holder 4 are provided. A BMC (Bulk Molding Compound) resin substrate 3 is mounted on the substrate holder 4.

After the space 7 in the vacuum chamber 6 was evacuated to 4×10⁻³ Pa, 100 ccm argon gas was introduced. The resin substrate 3 was then moved above the silver target 1 and was first subject to sputtering with silver for 60 seconds. Subsequently, the substrate 3 was moved above the titanium target 2 and was subject to sputtering with titanium for 5 seconds. The amount of electrical power supplied to the silver target 1 and the titanium target 2 were 1 KW and 0.1 KW, respectively.

The silver and titanium metal films were deposited to thicknesses of 150 nm and 1 nm, respectively.

Likewise, the sputtering apparatus as shown in FIG. 5 was used to deposit silver and titanium on a substrate as a second example of the production of the reflector film. Specifically, a BMC resin substrate 3 was mounted on the substrate holder 4. After the space 7 in the vacuum chamber 6 was evacuated to 4×10⁻³ Pa and 100 ccm argon gas was introduced into the space 7, the resin substrate 3 was moved above a silver target 1 and was subject to sputtering with silver for 60 seconds. Subsequently, the substrate was moved above a titanium target 2 and was subject to sputtering with titanium for 10 seconds. The electrical powers supplied to the silver target 1 and the titanium target 2 were 1 KW and 0.1 KW, respectively. The silver and titanium metal films were deposited to thicknesses of 150 nm and 2 nm, respectively.

The films deposited in the first and second examples were evaluated for weather resistance. The results are shown in Table 1 below.

TABLE 1

| | | | | Silver alloy |
|---|---|---|---|---|
| | First | Second | | (Commercial |
| Tests | example | example | Pure silver | product) |
| Heat resistance *1 | A | A | A | A |
| Humidity resistance *2 | A | A | C | B |
| Heat cycle test *3 | A | A | C | A |
| Anti-sulfuration property *4 | A | A | C | C |

*1: left in a 120° C. atmosphere for 24 hours
A: metallic luster, B: turned yellow, C: changed color, cracked
*2: left in a 50° C. atmosphere at RH 98% for 240 hours
A: metallic luster, B: white spots, C: entirely turned white
*3: 10 cycles of room temperature, −40° C., and 80° C. (RH90%) (1 cycle = 8 hours, total of 80 hours).
A: metallic luster, B: turned yellow, C cracked
*4: left in a desiccator with a 7% ammonium sulfide solution for 10 min.
A: metallic luster, B: partly changed color, C: entirely turned black or blackish color

For comparison, the results for a pure silver film and a commercially available silver alloy film (containing copper and palladium), each deposited without a protective film, are also shown in Table 1. The results of Table 1 indicate that the reflector films made in accordance with the presently disclosed subject matter (the first and second examples) are each improved in all of the evaluated properties for weather resistance.

The reflector films were also subjected to an anti-sulfuration test and the reflectance (%) at a wavelength of 550 nm was measured after the test. The results are shown in Table 2.

TABLE 2

| | | | | Silver alloy |
|---|---|---|---|---|
| | | Second | Pure | (Commercial |
| Anti-sulfuration test *1 | First example | example | silver | product) |
| Before the test | 97 | 96 | 96 | 95 |
| After the test | 96 | 95 | 5 | 25 |

*1 left in a desiccator with a 7% ammonium sulfide solution for 10 min.

For comparison, the reflectances of a pure silver film and a commercially available silver alloy film (containing copper and palladium), each deposited without a protective film, are also shown in Table 2. The results of Table 2 indicate that the reflectance decreased little after the anti-sulfuration test and the reflectance at 550 nm (center wavelength in the visible spectrum) was substantially maintained at the initial value in each of the exemplary reflector films made in accordance with the presently subject matter (the first and second examples). In contrast, the surface of the pure silver film (with no protective film) was sulfurated and turned black and the reflectance of the film at 550 nm decreased to 5% after the anti-sulfuration test. The reflectance of the silver alloy film (containing copper and palladium) also decreased to 25%. Though the decrease was not as large as that of the pure silver film, the silver alloy film is not suitable for practical use without provision of protective film.

While the silver or silver alloy film 23 was deposited by sputtering in the foregoing description, it may be deposited by vacuum deposition, ion-plating, etc. The undercoat 22 applied to the substrate 21 is optional: The silver or silver alloy film 23 and the titanium or titanium alloy film 24 may be deposited directly on the resin substrate 21 in this order without providing undercoat 22.

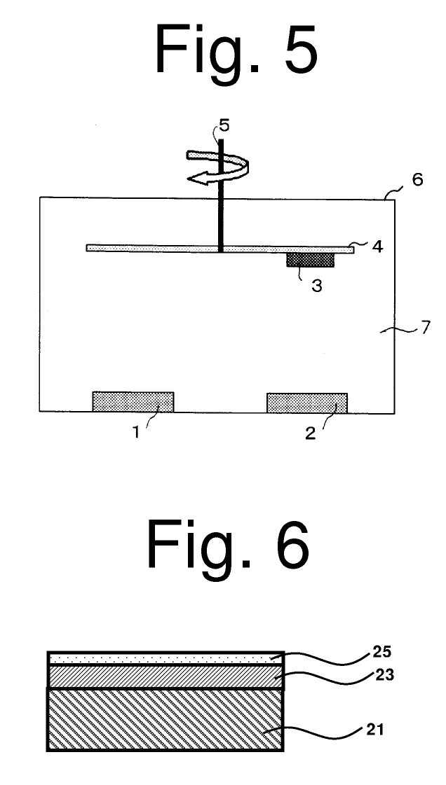

FIG. 6 is a diagram showing an exemplary construction of a reflector film according to a second exemplary embodiment of the presently disclosed subject matter. In FIG. 6, like elements are denoted by like reference numerals as in FIGS. 3 and 4. The reflector film in FIG. 6 can include a silver film or a silver alloy film 23 deposited on a predetermined substrate 21, and a SiAlON film 25 deposited on the silver or silver alloy film 23 to serve as a protective film.

The SiAlON film 25 has a composition represented by the following general formula: Si_{(6-Z)}Al_{Z}O_{Z}N_{(8-Z)} (0<Z≦4.2). SiAlON can be a solid solution consisting of (or comprising) silicon nitride substitutionally incorporating aluminum and oxygen. It has the same crystal structure as silicon nitride, but has higher stability and mechanical strength than silicon nitride.

In particular, SiAlON has a dense crystal structure and a high gas barrier property as compared to SiOx and can be used to form an effective protective film. The material is highly transparent in the entire visible spectrum. The reflectance of SiAlON does not decrease when the material is formed into a film, nor does its luster change. SiAlON can be formed into a film quickly and readily using a sputtering technique. The resulting film is more stable and less costly as compared to other protective films.

The substrate 21 may be a resin substrate, a metal substrate, a glass substrate or the like as in the first exemplary embodiment.

The silver or silver alloy film 23 can have a thickness of 50 nm to 500 nm and the SiAlON film 25 can have a thickness of 0.5 nm to 10 nm.

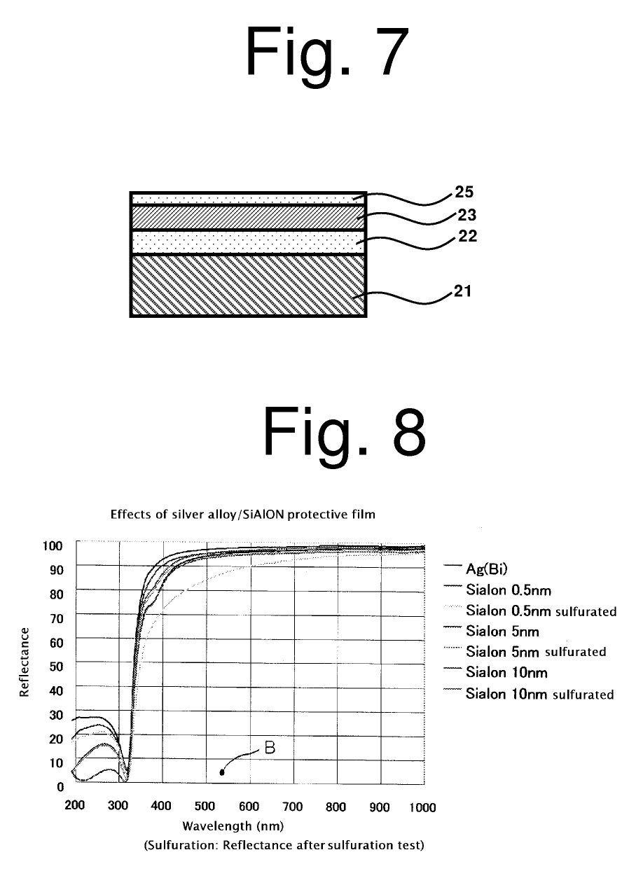

While the silver or silver alloy film 23 may be directly deposited on the substrate 21, it may be deposited on an undercoat 22 (such as an acrylic resin undercoat 22) deposited on the substrate 21, as shown in FIG. 7.

The reflector film having the above-described construction can include the silver or silver alloy film 23 deposited on the substrate 21, and the SiAlON film 25 deposited on the silver or silver alloy film 23 to serve as the protective film. The SiAlON film 25 serves not only to ensure a high gas barrier property of the reflector film (thus making an effective protective film), but also to keep the reflectance of the silver or silver alloy film high without deterioration.

Having the above-described advantageous features, the reflector film made in accordance with the second exemplary embodiment of the presently disclosed subject matter can be used, for example, in the above-described reflector 20 of the lighting apparatus (headlamp) shown in FIG. 1. In such a case, the reflector film of the second exemplary embodiment serves to ensure a high reflectance. This property, together with its high heat resistance, can help maintain the high quality of the reflector, and consequently can improve the quality of the lighting apparatus.

The process for forming the reflector film having a construction in accordance with the second exemplary embodiment of the presently disclosed subject matter (as shown in FIG. 6 or 7) can be carried out by sputtering. Specifically, the silver or silver alloy film is first deposited on the substrate by sputtering, and the SiAlON film is subsequently deposited also by sputtering.

For example, an undercoat 22 is applied to the surface of a synthetic resin material 21. Silver 23 is then deposited on the surface of the undercoat 22 by sputtering. Subsequently, SiAlON 25 is deposited also by sputtering. Silver 23 is typically deposited to a thickness of 50 nm or more, and generally to a thickness in the range of 50 nm to 500 nm. This silver may be any silver-based material containing 95% or more pure silver. For example, a silver alloy material containing metals such as copper, palladium, neodymium, gold, bismuth, indium and magnesium may be used. The SiAlON film 25 is typically deposited to a thickness of 0.5 nm or more, and generally to a thickness in the range of 0.5 nm to 10 nm.

The above-described production method in which the deposition process is carried out by sputtering can effectively keep dust particles from sticking to the reflector film during the deposition process. Thus, high production yields can be achieved. In contrast to conventional coating techniques, the deposition of the protective film by sputtering is effective in preventing sticking of dust particles to the film and can thus increase the production yield.

Since the deposition is a dry process, the method does not require the use of organic solvents. In contrast to coating techniques that require organic solvents, the deposition of the protective film by sputtering causes less environmental load and is advantageous in view of the health of the workers.

As a third example of the production of the reflector film, an acrylic undercoat was applied to a BMC (Bulk Molding Compound) resin substrate to a thickness of approximately 20 μm, and the coated substrate was placed in a sputtering apparatus to successively deposit a silver alloy film and a SiAlON protective film.

The silver alloy film was deposited by DC sputtering to a thickness of 100 nm using a silver alloy target (containing 1 wt % Bi). The sputtering was performed in a 100% Ar atmosphere for 60 seconds with a supplied electrical power of 1 KW.

Using a SiAlON target (Si_{5.5}Al_{0.5}O_{0.5}N_{7.5}, manufactured by Mitsubishi Material Corp.), the SiAlON protective film was deposited by RF sputtering to three different thicknesses of 0.5 nm, 5 nm, and 10 nm. The sputtering was performed in a 98% Ar+2% N₂ atmosphere for 30 seconds with a supplied electrical power of 0.5 KW.

As a fourth example of the production of the reflector film, an acrylic undercoat was applied to a BMC (Bulk Molding Compound) resin substrate to a thickness of approximately 20 μm, and the coated substrate was placed in a sputtering apparatus to successively deposit a silver alloy film and a SiOx protective film.

The silver alloy film was deposited by DC sputtering to a thickness of 100 nm using a silver alloy target (containing 1 wt % Bi). The sputtering was performed in a 100% Ar atmosphere for 60 seconds at a supplied electrical power of 1 KW.

Using an Si target (containing 99.99% Si), the SiOx protective film was deposited by reactive DC sputtering to a thickness of 5 nm. The sputtering was performed in a 50% Ar+50% O₂ atmosphere for 180 seconds with a supplied electrical power of 0.5 KW.

As a fifth example of the production of the reflector film, an acrylic undercoat was applied to a BMC (Bulk Molding Compound) resin substrate to a thickness of approximately 20 μm, and the coated substrate was placed in a sputtering apparatus to successively deposit a silver alloy film and a silicon nitride protective film.

The silver alloy film was deposited by DC sputtering to a thickness of 100 nm using a silver alloy target (containing 1 wt % Bi). The sputtering was performed in a 100% Ar atmosphere for 60 seconds with a supplied electrical power of 1 KW.

Using an Si target (containing 99.99% Si), the silicon nitride protective film was deposited by reactive DC sputtering to a thickness of 5 nm. The sputtering was performed in a 50% Ar+50% N₂ atmosphere for 60 seconds with a supplied electrical power of 0.5 KW.

To examine the performance of the protective film, the three reflector films that were prepared in the third example with the SiAlON films of different thicknesses were placed in a container with a 5% ammonium sulfide solution for 10 min. The reflectance of each reflector film was measured at different wavelengths before and after the 10-minute period. The results are shown in FIG. 8. Thus, FIG. 8 shows the relationship between the thickness of the SiAlON film and the sulfuration of silver.

As shown in FIG. 8, the decrease in the reflectance at 550 nm (center wavelength in the visible spectrum) was approximately 8% in the reflector film with 0.5 nm-thick SiAlON film. The decrease in the reflectance at 550 nm was 1% or less in the reflector film with 5 nm-thick SiAlON film.

In contrast, the reflectance at the visible wavelength decreased to 10% or less in each of the reflector films of the fourth and fifth examples after each film had been left in the 5% ammonium sulfide solution for 10 min. The reflectance at the visible wavelength of the reflector film having an exposed pure silver film (but not protective film) decreased to 5% or less (indicated by “B” in FIG. 8) after the film had been left in the 5% ammonium sulfide solution for 10 min.

These results indicate that each of the 0.5 nm- to 10 nm-thick SiAlON protective films can effectively keep the reflectance of the reflector film high, and in particular, effectively prevent the decrease in the reflectance when exposed to a sulfuration atmosphere. With a SiAlON film deposited thereon, the reflector films exhibited high heat resistance by retaining good metallic luster after the heat resistance test.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents. All related art references described above are hereby incorporated in their entirety by reference.

What is claimed is:

1. A reflector film comprising:
at least one of a silver film and a silver alloy film; and
at least one film selected from the group consisting of a titanium film, a titanium alloy film, and a SiAlON (general formula Si_{(6-Z)}Al_{Z}O_{Z}N_{(8-Z)} (0<Z≦4.2)) film serving as a protective film deposited on the at least one of the silver film and the silver alloy film.

2. The reflector film according to claim 1, wherein at least one of the silver film and silver alloy film has a thickness of 50 nm to 500 nm and at least one of the titanium film and titanium alloy film has a thickness of 0.1 nm to 2 nm and is deposited on the at least one of the silver film and silver alloy film.

3. The reflector film according to claim 1, wherein at least one of the silver film and silver alloy film has a thickness of 50 nm to 500 nm and the SiAlON (general formula Si_{(6-Z)}Al_{Z}O_{Z}N_{(8-Z)} (0<Z≦4.2)) film has a thickness of 0.5 nm to 10 nm and is deposited on the at least one of the silver film and silver alloy film.

4. A reflector comprising:
a substrate having a predetermined shape;
at least one of a silver film and a silver alloy film deposited on the substrate; and
at least one film selected from the group consisting of a titanium film, a titanium alloy film, and a SiAlON (general formula Si_{(6-Z)}Al_{Z}O_{Z}N_{(8-Z)} (0<Z≦4.2)) film serving as a protective film and deposited on the at least one of the silver film and silver alloy film.

5. The reflector according to claim 4, wherein the at least one of the silver film and silver alloy film has a thickness of 50 nm to 500 nm and at least one of the titanium film and titanium alloy film has a thickness of 0.1 nm to 2 nm and is deposited on the at least one of the silver film and silver alloy film.

6. The reflector according to claim 4, wherein the at least one of the silver film and silver alloy film has a thickness of 50 nm to 500 nm and the SiAlON (general formula Si_{(6-Z)}Al_{Z}O_{z}N_{(8-Z)} (0<Z≦4.2)) film has a thickness of 0.5 nm to 10 nm and is deposited on the at least one of the silver film and silver alloy film.

7. The reflector according to claim 4, wherein the reflector is configured for use in a vehicular lighting device.

8. The reflector according to claim 4, wherein the predetermined shape of the substrate includes at least one of a revolved paraboloid, a spheroid, and a free curved surface.

9. The reflector according to claim 7, wherein the lighting device is a projector type headlight.

10. The reflector according to claim 8, wherein the reflector is configured for use in a vehicular lighting device, and the lighting device is a projector type headlight.

11. A method for producing a reflector film, comprising:
providing a substrate;
depositing at least one of a silver and a silver alloy film on the substrate by sputtering; and
subsequently depositing at least one film selected from the group consisting of a titanium film, a titanium alloy film, and a SiAlON (general formula Si_{(6-z)}Al_{Z}O_{Z}N_{(8-z)} (0<Z≦4.2)) film by sputtering.

12. A lighting apparatus comprising a light source and the reflector according to claim 4 located adjacent the light source.

13. The lighting apparatus according to claim 12, wherein the at least one of the silver film and silver alloy film has a thickness of 50 nm to 500 nm and at least one of the titanium film and titanium alloy film has a thickness of 0.1 nm to 2 nm and is deposited on the at least one of the silver film and silver alloy film.

14. The lighting apparatus according to claim 12, wherein the at least one of the silver film and silver alloy film has a thickness of 50 nm to 500 nm and the SiAlON (general formula Si_{(6-Z)}Al_{Z}O_{Z}N_{(8-Z)} (0<Z≦4.2)) film has a thickness of 0.5 nm to 10 nm and is deposited on the at least one of the silver film and silver alloy film.

15. The lighting apparatus according to claim 12, wherein the lighting apparatus is configured for use in a vehicular lighting device.

16. The lighting apparatus according to claim 13, wherein the lighting apparatus is configured for use in a vehicular lighting device.

17. The lighting apparatus according to claim 14, wherein the lighting apparatus is configured for use in a vehicular lighting device.

18. The lighting apparatus according to claim 15, wherein the reflector has a surface shape selected from at least one of a revolved paraboloid, a spheroid, and a free curved surface.

19. The lighting apparatus according to claim 16, wherein the reflector has a surface shape selected from at least one of a revolved paraboloid, a spheroid, and a free curved surface.

20. The lighting apparatus according to claim 17, wherein the reflector has a surface shape selected from at least one of a revolved paraboloid, a spheroid, and a free curved surface.

21. The lighting apparatus according to claim 15, wherein the lighting apparatus is configured for use in a projector type headlight.

22. The lighting apparatus according to claim 16, wherein the lighting apparatus is configured for use in a projector type headlight.

23. The lighting apparatus according to claim 17, wherein the lighting apparatus is configured for use in a projector type headlight.
